(19) United States
(12) Patent Application Publication
(10) Pub. No.: US 2015/0074684 A1
(43) Pub. Date: Mar. 12, 2015

(54) TECHNIQUES FOR ENABLING INTER-PROCESS COMMUNICATION (IPC) AMONG MULTIPLE PERSONAS IN A MOBILE TECHNOLOGY PLATFORM

(71) Applicant: CELLROX, LTD., Tel Aviv (IL)

(72) Inventors: Amir GOLDSTEIN, Tel Aviv (IL); Micha KALFON, Tel Aviv (IL); Oren LAADAN, New York, NY (US); Alexander Edward VAN'T HOF, New York, NY (US)

(73) Assignee: CELLROX, LTD., Tel Aviv (IL)

(21) Appl. No.: 14/484,131

(22) Filed: Sep. 11, 2014

Related U.S. Application Data
(60) Provisional application No. 61/876,590, filed on Sep. 11, 2013.

(51) Int. Cl. G06F 9/54; G06F 9/46

(52) U.S. Cl. CPC G06F 9/546; G06F 9/466
USPC 719/313

(57) ABSTRACT

A method and system are provided for performing an inter-process communication (IPC) transaction among multiple personas in a mobile technology platform. The method includes receiving a request for an IPC transaction from an initiating persona to transfer data to at least one receiving persona, wherein the initiating and receiving personas are part of the multiple personas; analyzing the request to identify whether the initiating persona has permissions to transfer the data to the at least one receiving persona; upon identifying that the initiating persona has permissions to transfer the data, receiving the data from the initiating persona, when the initiating persona has the required permissions; analyzing the received data to determine compatibility with the at least one receiving persona; and upon determining that the data is compatible, enabling execution of the IPC transaction, thereby allowing the transfer of data.

### CROSS-REFERENCE TO RELATED APPLICATIONS

This application claims the benefit of U.S. Provisional Patent Application No. 61/876,590 filed on Sep. 11, 2013, the contents of which are hereby incorporated by reference.

### TECHNICAL FIELD

The present invention relates generally to mobile technology platforms (MTPs), and more specifically to systems and methods for providing services to multiple personas of MTPs.

### BACKGROUND

Inter-process communication (IPC) is a set of techniques used to exchange data among multiple processes. An IPC technique may be, but not limited to, message passing, synchronization, memory or data sharing, and so on. Typically, processes run instances of programs. In certain software products, the processes can reside in namespaces. A namespace is a container that isolates a process contained therein from other processes run in other namespaces. As such, IPC is not enabled between processes residing in different namespaces.

Existing technology enables the coexistence of multiple personas on a mobile technology platform (MTP). Each persona may have a unique set of user preferences associated with the persona. The MTP may be embodied in a computing device. The advancements in this field have spawned a new need to enable a communication option adjusted for the exchange of data between multiple personas coexisting in the MTP. The problem is that different personas may have different security classifications and attributes depending on the user preferences and on the policy of an operating system (OS) of the MTP. Thus, by enabling communication between the multiple personas, existing solutions may leave the MTP susceptible to security issues such as unauthorized sharing of data among personas.

In a MTP, a plurality of services provided by the OS are utilized by applications (such as mobile applications or “apps”) executed over the MTP. However, such services are not designed to provide services to multiple personas, and thus may not be aware of the existence of the multiple personas. Thus, IPC communication problems between personas can arise.

In addition, each namespace defined in a MTP may contain a different set of personas. A problem may arise when a service or an application utilizing the service operates in one persona through one namespace and is not aware of another application/service which is operated by another persona through a different namespace. Thus, IPC transactions between personas contained in distinct namespaces lacking features that enable communication among the namespaces.

Therefore, in order to allow coexistence of multiple personas on a MTP there is a need to provide an efficient solution for enabling secured and transparent IPC among personas in different namespaces.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single aspect or multiple embodiments of the disclosure.

As an example of the above, the some embodiments disclosed herein enable a secured access to a service in multiple personas coexisting in a mobile technology platform, thereby enable the communication between the personas in the platform without causing security risks to personas. As a result, the disclosed embodiments allow seamless adaptation of a non-multi-persona-aware MTP into a multi-persona environment. That is, the embodiments disclosed herein allow IPC transactions between services and personas operating in isolated environments without modifying or programming the services to allow such transactions.

The disclosure further relates in various embodiments to a method and system for performing an inter-process communication (IPC) transaction among multiple personas in a mobile technology platform. The method includes receiving a request for an IPC transaction from an initiating persona to transfer data to at least one receiving persona, wherein the initiating and receiving personas are of the multiple personas; analyzing the request to identify whether the initiating persona has permissions to transfer the data to the at least one receiving persona; upon identifying that the initiating persona has permissions to transfer the data, receiving the data from the initiating persona, when the initiating persona has the required permissions; analyzing the received data to determine compatibility with the at least one receiving persona; and upon determining that the data is compatible, enabling execution of the IPC transaction, thereby allowing the transfer of data.

The disclosure further relates in various embodiments to a method and system for performing inter-process communication (IPC) transactions to provide services to multiple personas through a mobile technology platform. The method includes receiving a request for an IPC transaction from a requesting service to provide services to at least one persona of the multiple personas; analyzing the request to determine the services provided by the requesting service; identifying at least one persona in need for at least one service of the services provided by the requesting service; and enabling execution of the IPC transaction with the at least one identified persona.

The disclosure further relates in various embodiments to a method and system for inter-process communication (IPC) among a plurality of personas in a mobile technology platform. The method includes registering a service operable in a first persona of the plurality of personas as a global service; publishing the global service as available to at least a second persona of the plurality of personas; and allowing direct IPC communication between the global service to at least a service operable in the at least second persona, wherein the first persona and the at least second persona are contained in at least two different namespaces.

### BRIEF DESCRIPTION OF THE DRAWINGS

The subject matter disclosed herein is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic block diagram of a mobile technology platform (MTP) operative according to an embodiment;

FIG. 2 is a schematic block diagram of an apparatus for implementation of the operation of the MTP according to an embodiment;

FIG. 3 is a flowchart describing a method for transferring data among multiple personas of the MTP according to one embodiment; and

FIG. 4 is a flowchart describing a method for providing services by a single service to a persona according to one embodiment.

### DETAILED DESCRIPTION

It is important to note that the embodiments disclosed by herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In some exemplary embodiments, a mobile technology platform (MTP) and method allows secured IPC transaction between a service and/or an application operative in one persona to provide services to another persona while mitigating potential security risks to the MTP and/or any breach of a policy defining a set of access permissions to a persona. In some exemplary embodiments, secured IPC transactions can be performed among different personas coexisting in isolated environments. The enablement of the IPC transaction is transparent to the services, applications, and personas operative in the MTP. It should be noted that the enablement of IPC transactions is performed while maintaining the original isolations provided by namespaces.

In an embodiment, a registration through an agent, unique to the MTP, takes place. This allows, for example, a single available audio service, to provide services to any one of the multiple personas of the MTP. The disclosed agent further acts as a reverse proxy to receive any necessary answers respective of providing such shared services. In an embodiment, the agent acts as persona router allowing transfer of data among the ‘isolated personas’.

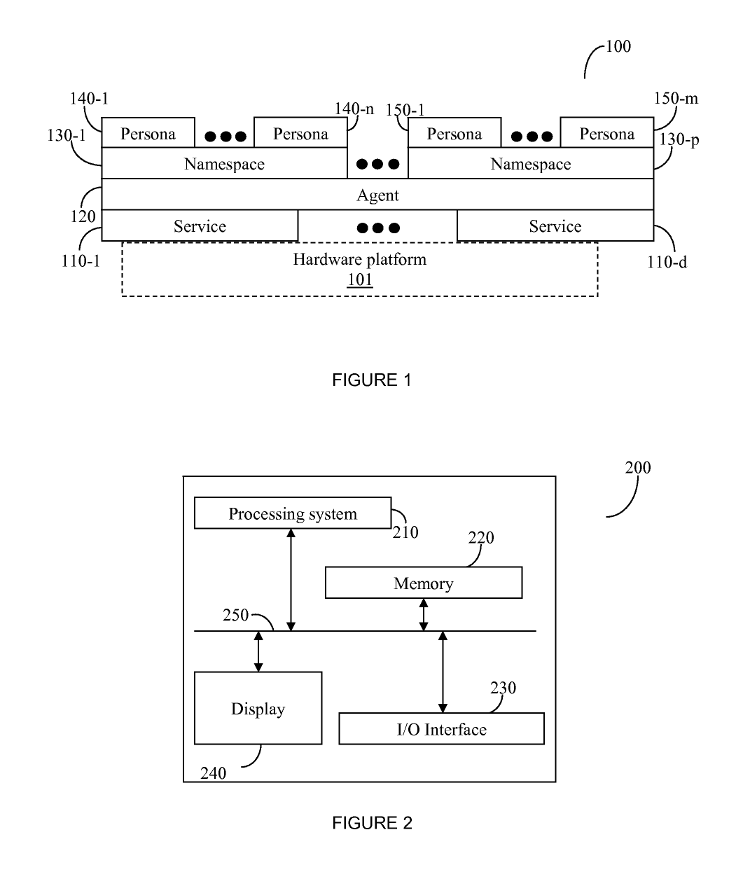

FIG. 1 is an exemplary and non-limiting schematic diagram of a MTP 100 operative according to an embodiment. The MTP 100 may be executed in a computing device. Such a computing device may be, for example, a cellular phone, a smartphone, a tablet device, a notebook computer, a laptop computer, an intra-vehicle infotainment (IVI) system, a wearable computing device, any object with an Internet connection, and the like. The MTP 100 comprises a services layer which may include one or more services 110-1 through 110-d. Each one of the services 110 may be any program or a process provided by an operation system (OS) hosting the MTP 100. Examples for such services include an audio service, a network connectivity service, a power management service, and the like. The services 110 also include one or more services provided by an application (“app”) downloaded and installed in the computing device. The MTP 100 also includes an agent 120 communicatively connected to a plurality of namespaces 130-1 through 130-p and to the services 110. In certain implementations, the agent 120 is configured to execute the embodiments disclosed herein. Namespaces 130 allow defining different and separate instances of, e.g., personas, that operate independent of each other. Thus, namespaces 130 provide basic isolation between personas, thereby ensuring that each namespace 130 “container” cannot affect other personas contained in the other namespaces 130.

As shown in FIG. 1, each namespace 130-1 through 130-p may contain multiple personas. As an example, namespace 130-1 may contain one or more personas 140-1 through 140-n while namespace 130-p may contain one or more personas 150-1 through 150-m. Each persona 140 and/or 150 can be executed over the MTP 100, continuously, intermittently, or responsive of a user activation. In the embodiment illustrated in FIG. 1, the personas 150 contained in the namespace 130-p are isolated from the personas 140 contained in the namespace 130-1. It should be noted that also one or more of the services 110 may be contained in a namespace, thereby, providing “isolation” between services. It should be further noted that a persona may implement services of the OS, e.g., a service 110. It should be further noted that some services 110 may be exclusively accessed or executed through a persona.

Each persona 140-1 through 140-n and/or 150-1 through 150-m is designed respective of a unique set of user preferences associated with the persona. As an example, a persona 140-1 may be a personal persona, that is, a persona designated for a personal use, while a persona 150-1 may be a business persona, that is, a persona designated for a business use. Moreover, each persona 140-1 through 140-n and/or 150-1 through 150-m of each namespaces 130-1 through 130-p includes a namespace identifier. Furthermore, each persona 140-1 through 140-n and/or 150-1 through 150-m of each of the namespaces 130-1 through 130-p has a local name.

It should be understood that each persona 140-1 through 140-n and/or 150-1 through 150-m may be aware of a different set of services 110-1 through 110-d, and/or 150-1 through 150-m.

The agent 120 allows a service, for example, service 110-1 operative in one persona, for example, persona 140-1 to provide services through IPC to another persona, for example, persona 150-1 without causing security risks to the MTP 100. The IPC is performed in a transparent manner, that is, without modifying the operation of any of the services 110, the personas 140 and 150, applications, or any other process executed in the MTP 100. It should be noted that the services 110 may not be limited to MTP 100 design services. Accordingly, the agent 120 is configured to provide an automatic reverse proxy service to receive any answers respective of providing such shared service 110-1. The agent 120 is further configured to analyze the received answer and modify at least a portion such answer.

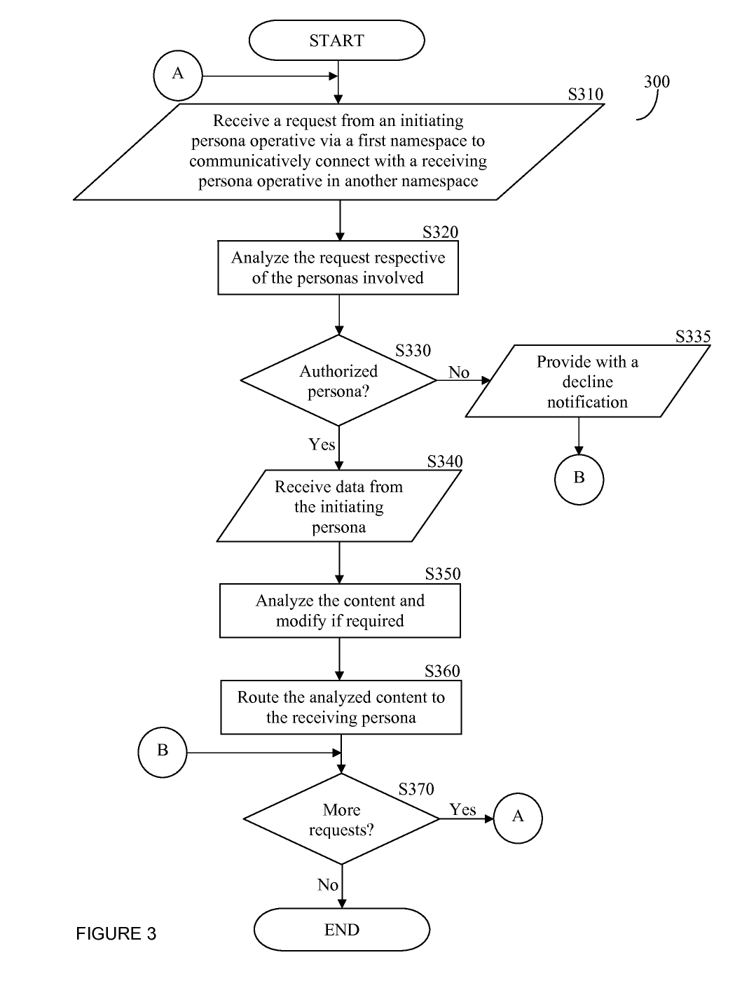

As an example, the agent 120 is configured to modify at least a portion of information to create a readable version respective of the service 110-1 and each persona 140-1 and/or 150-1. As another example, the agent 120 is configured to remove at least a portion of information respective of each persona 140-1 and/or 150-1 security classification. It should be understood that security classification of each persona 140-1 and/or 150-1 may be identified by, for example, analyzing the unique set of user preferences and/or a policy associated with each persona 140-1 and/or persona 150-1. Such operation is described in greater detail below with reference to FIG. 3.

The agent 120 is configured to receive a request to perform IPC transactions. An example for an IPC transaction is a binder transaction implemented by a binder protocol of Android® operating system (OS). The IPC request may be received from one persona, for example, an initiating persona 140-1 of the namespace 130-1 to communicatively connect with another persona, for example, a receiving persona 150-1 of the namespace 130-p. Upon receiving the namespace identifier of the initiating persona 140-1 and/or the local name of the initiating persona 140-1, the agent 120 is configured to determine whether the initiating persona 140-1 is authorized to communicate with the receiving persona 150-1. This is performed, for example, by analyzing the initiating persona's 140-1 interface to identify permissions associated with the initiating persona 140-1. It should be understood that such permissions are determined respective of the unique set of user preferences and/or a configured policy associated with the initiating persona 140-1. The security policy may be configured, for example, by information technology (IT) personnel.

In an embodiment, the agent 120 handles the IPC communication between the initiating persona 140-1 and the receiving persona 150-1 by intercepting all IPC requests to a (remote) service. This may be performed either by lurking on the IPC mechanism or by posing as the service in the other (receiving) persona 150-1.

In another embodiment, IPC communication between personas and particularly between services executed within personas 140 and/or 150 is performed directly between the personas. To this end, a service in one persona is registered as a global service. The agent 120 publishes the global service as available or visible to at least one other persona. Thereafter, personas, in different namespaces 130, may connect and communicate with that service without passing through the agent 120. For example, a global service may be a service in the receiving persona 150-1. The initiating persona 140-1 communicates directly through the “global” service without sending requests to the agent 120. It should be noted that the registration and publishing of the global service is performed only once per a target persona. That is, a service 110 is published to be available in a specific persona only once and can be published multiple times per each distinct persona.

According to one embodiment, the agent 120 is configured to allow transferring of data among personas located in different namespaces 130. To transfer the data, the agent 120 may invoke or execute a persona router service. When the agent 120 receives the data from the initiating persona 140-1, the data may be modified respective of the receiving persona 150-1. As an example, but without limitation, the data may be filtered respective of the receiving persona 150-1 permissions. Moreover, the data may be customized respective of software capabilities of the receiving persona 150-1. The data may be, but not limited to, messages, data sharing, and so on. In an embodiment, the agent 120 may configured with a set of policies how to route messages of a certain types. A message may be unicast to the receiving persona 150-1, but also multicast or broadcast to the other personas.

The MTP 100 illustrated in FIG. 1 is executed over a hardware (HW) platform 101. The platform 101 includes at least a processor and a memory connected to the processor (not shown in FIG. 1). The memory contains a plurality of instructions that when executed by the processor allow the operations of the any of the services 110, the agent 120, and any of the personas 140-n and/or persona 150-m. An exemplary implementation of such platform is illustrated below in FIG. 2.

In an embodiment, the agent 120 is a reverse proxy routing requests between personas to allow services sharing. As noted above, services operative in personas 140 and 150 cannot directly communicate unless a service is registered as a global service or a communication link is established between personas. Thus, not all services in one persona, for example, persona 150-1 are visible to another persona, for example, persona 140-1. Following is a non-limiting example for the operation of the reverse proxy according to one embodiment. The persona 150-1 requests for a service S0 which resides in the persona 140-1. In executing the request for service S0, persona 140-1 requests for a service S1, which resides in the initiating persona 150-1. However, the service S1 is not visible in or available to the persona 140-1. That is, persona 140-1 does not know that the service S1 is in the initiating persona 150-1. The agent 120 intercepts the request from persona 140-1 and routes the request to persona 150-1, thereby allowing IPC between personas 140-1 and 150-1.

FIG. 2 is an exemplary and non-limiting schematic diagram of an apparatus 200 (i.e., computing device) configured to allow the operation of the MTP 100. The apparatus 200 typically contains a processing system 210 and a memory 220 connected to the processing system 210. The memory 220 contains a plurality of instructions that are executed by the processing system 210. Specifically, the memory 220 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The processing system 210 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The apparatus 200 further contains an interface for receiving inputs and sending outputs, such as, I/O interface 230. Through the I/O interface 230 input/output signals, required or otherwise provided by the services (e.g., services 110), are received or transmitted. The various elements of the apparatus 200 are connected by means of a bus 250 for exchanging data as may be required.

In an exemplary embodiment, the apparatus 200 also includes a display 240, designed on which the multiple personas (e.g., personas 140 and 150) can be displayed and render graphical user interface elements, allowing users to select an active persona to interact with. The active persona and any notifications generated by active personas or personas running in the foreground are displayed over the display 240. Various techniques for selecting and displaying active persona can be found in U.S. patent application Ser. No. 14/262,318 titled “SYSTEMS AND METHOD FOR IMPLEMENTING MULTIPLE PERSONAS ON MOBILE TECHNOLOGY PLATFORMS”, which is assigned to the common assignee and incorporated herein by reference.

The apparatus 200 may be realized as a cellular phone, a smartphone, a tablet device, a notebook computer, a wearable computing device, a laptop computer, an IVI system, an object with an internet connection, and the like.

FIG. 3 shows an exemplary and non-limiting flowchart 300 illustrating a method for enabling the transfer of data among multiple personas (e.g., personas 140 and 150) according to an embodiment.

In S310, a request to perform an IPC transaction for transferring data is received. In an embodiment, such a request can be intercepted by, for example, the agent 120. The request is received from an initiating persona contained in a first namespace to communicatively connect with a receiving persona contained in a second namespace. For example, the initiating persona is the persona 140-1 contained in the namespace 130-1 and the receiving persona 150-1 is contained in the namespace 130-p. According to one embodiment, the request is received together with a local name of the initiating persona.

In S320, the request is analyzed to identify whether the initiating persona is authorized to connect or otherwise communicate with the receiving persona. In an embodiment, this is performed, for example, by analyzing the initiating persona's interface to identify a unique set of user preferences and/or a security policy associated with the interface. The unique set of user preferences of a persona, and particularly of the initiating persona defines in part a set of permissions. Thereby, by analyzing these preferences it can be determined if the initiating persona can access the receiving persona. In one embodiment, the interface of the receiving persona interface may be also analyzed to determine if external connection requests can be accepted.

As a non-limiting embodiment, the initiating persona may have the permissions to operate in a work environment of an MTP, such as, the MTP 100 (e.g., the initiating persona is a business persona). Upon receiving a request to perform an IPC transaction, it is determined if the receiving persona also has permissions to operate in the work environment. If so, the initiating persona is authorized to communicatively connect with the receiving persona.

In S330, it is checked whether the initiating persona is authorized to communicatively connect with the receiving persona, and if so execution continues with S340; otherwise, execution continues with S335. In S335, a decline notification is sent to the initiating persona. In some embodiments, S335 is optional.

In S340, data to be routed to the receiving persona is received from the initiating persona. Such data may include, for example, communication massages, data sharing related to services (e.g., services 110-1 through 110-d) operative via the initiating persona, and so on.

In S350, the received data is analyzed to determine if any adaptations or modifications are required before routing the data to the receiving persona. According to one embodiment, the data may be modified to be compatible with the receiving persona's permissions and/or software capabilities. As a non-limiting example, the received data may contain a contact list with phone numbers of family members and coworkers that can be accessed through initiating persona. The contact list is filtered so that phone numbers of the family members will be blurred or blocked, thereby providing only contact information of coworkers to the receiving persona. As another non-limiting example, the data sent from an initiating to a receiving persona may include information respective of a service operative via the initiating persona. A readable version of such information is created by adjusting the information respective of the receiving persona's software capabilities. In an embodiment, it is determined if the received data should be broadcast or multicast to personas, other than the receiving persona.

In S360, the requested IPC transaction between the initiating persona 140-1 and the receiving persona 150-1 is enabled. In response, the data, which may be in its modified form, is routed from the initiating persona to the receiving persona. In S370, it is checked whether there are additional requests for IPC transactions, and if so execution continues with S310; otherwise, execution terminates.

It should be noted that receiving persona may respond with data to be transferred to the initiating persona. Such a response is handled as discussed herein with reference to S350 and S360.

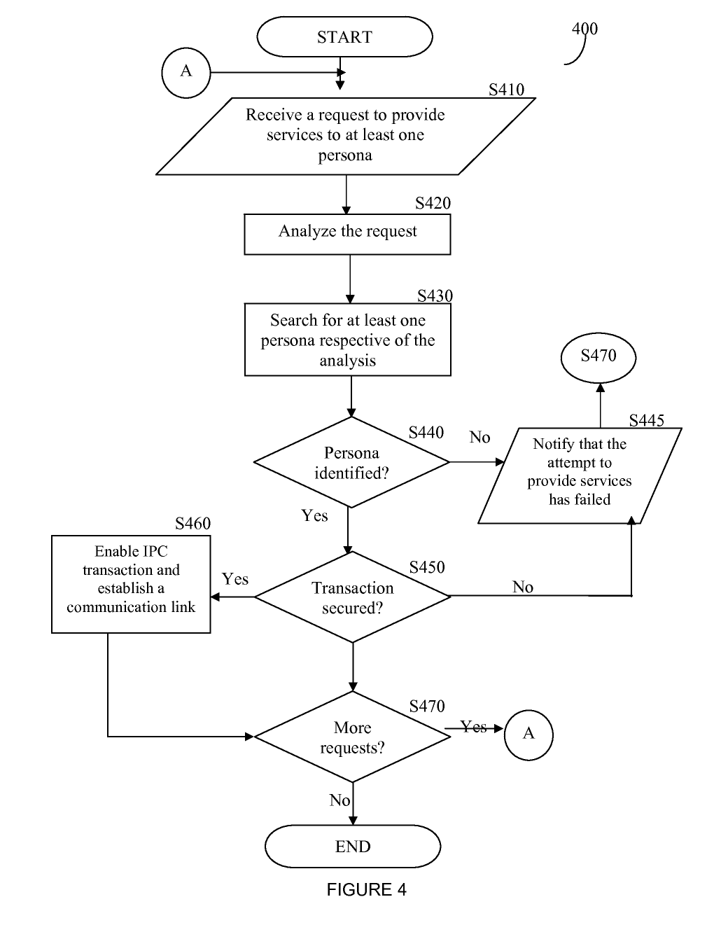

FIG. 4 depicts an exemplary and non-limiting flowchart 400 illustrating a method for enabling a single service to support multiple personas of the MTP 100 according to an embodiment.

In S410, a request to perform an IPC transaction to provide services to at least one persona is received. The request may be initiated by a service (e.g., a service 110), a service executed in a persona, a service contained in a namespace, a persona, an application, or any process of the operating system (collectively referred to as a “requesting service”). For example, a service 110-1 may request to provide services to one or more personas 140 and 150 illustrated in FIG. 1. As noted above, a service may be any program, designed to support one or more entities of an MTP, such as, the MTP 100 illustrated in FIG. 1.

In S420, the request is analyzed to determine the functionalities provided by the requesting service. In an embodiment, this includes analyzing the requesting service's interface which typically contains information about functions, operation, and the communication options the service is programmed with.

In S430, a search for at least one appropriate persona respective of the analysis is performed. In an embodiment, S430 includes searching through the unique set of user preferences associated with each persona or through their interfaces. For each persona found in the search, it is further determined if there is a need for such persona to obtain services by the requesting service.

In S440, it is checked whether there is at least one persona in need for the services provided by the requesting service, and if so execution continues with S450. Otherwise, execution continues with S445, where a decline notification may be sent to the requesting service. In some embodiments, for each persona identified as in need for services, it is checked if the requesting service meets a security policy defined for the identified persona. In S450, it is checked, based on the defined security policy, whether the services provided by the requesting service poses a security risk above a predefined threshold, and if so execution continues with S445; otherwise, execution reaches to S460. It should be noted that the tests for searching for an appropriate persona that can obtain services from the requesting services may be performed in different order than that described herein.

In S460, the IPC transaction is executed in order to enable the requesting service to provide services to the persona(s) identified as passed the tests performed in S440 and S450. In one embodiment, the IPC transaction is a binder transaction performed using a binder protocol, in which a communication link between the requesting service and each identified persona is generated. In an embodiment, data from/to the requesting service to/from the persona is modified to allow compatibility with the receiving persona. Examples for possible modifications of data provided by a service are demonstrated above.

According to one embodiment, an aggregation of data related to a plurality of personas may be performed when communicating with a requesting service. As an example, a single service may employ the Bluetooth® protocol when an exchanging of data is required. In order to identify which persona has an active Bluetooth®, the interfaces of the personas that coexist in the MTP 100 are analyzed and the total number of personas having an active Bluetooth® are determined. The requesting services can be notified respective of the total number of personas having the active Bluetooth®. In S470, it is checked whether there are additional requests and if so execution continues with S410; otherwise, execution terminates.

As a non-limiting example for the operation of the method disclosed with reference to FIG. 4, an audio service is configured to record, store, and reproduce sound by encoding an audio signal in its digital form respective of an input of an analog signal. A request from the audio service to provide services to personas is received. In response, the interface of the audio service is analyzed to identify if the audio service is configured to receive analog signal from at least one persona. It is further checked whether such persona requires a rendering of a digital audio signal by the audio service. Upon identifying at least one persona that requires such service, it is further checked whether the use of the audio service poses a security risk to the persona identified as in need for producing a digital signal. If the security test is passed a communication link is established between the audio service and the persona, thereby any analog audio signal captured by the persona is forwarded to the audio service.

In the method described with reference to FIG. 4, the IPC communication between services and/or personas contained in different namespaces is performed by means of an entity, e.g., the agent 120 through which all IPC requests are passed. In another embodiment, such an entity, e.g., the agent 120 can facilitate the communication between services and/or personas merely by registration and publication of one or more services (hereinafter “global services” or a “global service”).

Specifically, a service operates in one persona is registered as a global service. Then, the global service is published as available to other personas in the MTP. The other personas are in different namespaces than the namespace of the persona having the global service. It should be noted that the registration and publication of the global service is performed only once per a target persona. Furthermore, the registration and publication of the global service are transparent to the personas, services, and/or application executed in the MTP.

Thereafter, IPC communication between the global service and personas (or services operable in the personas) is performed directly. Furthermore, IPC communication with global service is transparent to the personas, services, and/or application executed in the MTP. Thus, no modification is required.

This embodiment is particularly useful for execution Android® binder transactions. Because it allows publishing a binder handler of one persona inside another persona in a transparent way.

In an exemplary implementation, the methods discussed with reference to FIGS. 3 and 4 may be performed by the agent 120 of the MTP 100. It should be noted that method discussed with reference to FIGS. 3 and 4, the initiating and the receiving personas may be any persona operable in the MTP. The definition of the “initiating persona” and the “receiving persona” is provided herein merely for the sake of brevity of the description. That is, a persona may act as an initiating persona or a receiving persona.

The embodiments disclosed herein may be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for performing an inter-process communication (IPC) transaction among multiple personas in a mobile technology platform (MTP), comprising:
receiving a request for an IPC transaction from an initiating persona to transfer data to at least one receiving persona, wherein the initiating persona and the at least one receiving persona are part of the multiple personas;
analyzing the request to identify whether the initiating persona has permissions to transfer the data to the at least one receiving persona;
upon identifying that the initiating persona has permissions to transfer the data, receiving the data from the initiating persona, when the initiating persona has the required permissions;
analyzing the received data to determine compatibility with the at least one receiving persona; and
upon determining that the data is compatible, enabling execution of the IPC transaction, thereby allowing the transfer of data.

2. The method of claim 1, wherein the multiple personas are contained in at least two different namespaces.

3. The method of claim 2, wherein the initiating persona is contained in a first namespace and the at least one receiving persona is contained in a second namespace, wherein the first and second namespaces are different.

4. The method of claim 1, wherein the received data is at least one of: data sharing and messages.

5. The method of claim 1, wherein the received data is of a service operative on the MTP via the initiating persona.

6. The method of claim 1, wherein each persona is defined with a unique set of user preferences associated with a respective persona.

7. The method of claim 6, wherein the permissions of the initiating persona is determined based on at least one of: the unique set of user preferences, and a security policy associated with the initiating persona.

8. The method of claim 1, further comprising:
modifying the received data enable compatibility of the received data with the at least one receiving persona.

9. The method of claim 1, wherein enabling the execution of the IPC transaction further comprising:
routing the received data to the at least one receiving persona.

10. The method of claim 9, further comprising at least one of:
broadcasting the data to the plurality of personas; and
multicasting the data to a group of personas of the plurality of personas.

11. The method of claim 1, wherein the IPC transaction is at least a binder transaction.

12. The method of claim 1, further comprising:
receiving a response from the at least one receiving persona;
analyzing the received response to determine compatibility of the at least one receiving persona with the initiating persona; and
relaying the response to the initiating persona.

13. The method of claim 12, wherein relaying the response to the received response to the initiating persona further comprising:
modifying the response to allow compatibility with the initiating persona.

14. The method of claim 1, wherein the request for the IPC transaction request further includes: a request to obtain data from the at least one receiving persona.

15. The method of claim 1, further comprising:
reverse proxying of requests for services initiated by the at least one receiving persona.

16. A non-transitory computer readable medium having stored thereon instructions for causing one or more processing units to execute the method according to claim 1.

17. A system for performing an inter-process communication (IPC) transaction between an initiating persona and at least one receiving persona in a mobile technology platform (MTP), comprising:
a processor; and
a memory communicatively connected to the processor, the memory containing instructions that, when executed by the processor, configure the processor to:
receive a request for an IPC transaction from an initiating persona to transfer data to the at least one receiving persona, wherein the initiating persona and the at least one receiving persona are part of the multiple personas;
analyze the request to identify whether the initiating persona has permissions to transfer the data to the at least one receiving persona;
upon identification that the initiating persona has permissions to transfer the data, receive the data from the initiating persona, when the initiating persona has the required permissions;
analyze the received data to determine compatibility with the at least one receiving persona; and
upon determination that the data is compatible, enable execution of the IPC transaction, thereby allowing the transfer of data.

18. A method for performing inter-process communication (IPC) transactions to provide services to multiple personas through a mobile technology platform (MTP), comprising:
receiving a request for an IPC transaction from a requesting service to provide services to the multiple personas;
analyzing the request to determine the services provided by the requesting service;
identifying at least one persona of the multiple personas in need for at least one service of the services provided by the requesting service; and
enabling execution of the IPC transaction with the at least one identified persona.

19. The method of claim 18, further comprising:
determining whether the requesting service breaches an access policy of the at least one identified persona; and
upon determining that the access policy has not been breached, establishing a communication link between the requesting services and the at least one identified persona.

20. The method of claim 19, wherein the security threat is determined based on a security policy defined for the at least one identified persona.

21. The method of claim 18, further comprising:
receiving over the communication link data from at least one of: the requesting service, and the at least one identified persona.

22. The method of claim 21, further comprising:
aggregating data received from the at least one identified persona.

23. The method of claim 21, further comprising:
modifying the received data to enable compatibility with a recipient of the data, wherein the recipient of the data is any one of: the requesting service and the at least one identified persona.

24. The method of claim 18, further comprising:
upon failing to identify the at least one persona, sending a notification to the requesting service.

25. The method of claim 18, wherein the multiple personas are contained in at least two different namespaces.

26. The method of claim 25, wherein the requesting service is any one of: a process of an operating system and a process of an application installed on the MTP.

27. The method of claim 26, wherein the requesting service is at least one of:
a service executed in a persona, a service contained in a namespace, and a persona.

28. The method of claim 18, further comprising:
reverse proxying of requests for services initiated by the at least one identified persona.

29. A non-transitory computer readable medium having stored thereon instructions for causing one or more processing units to execute the method according to claim 18.

30. A method for inter-process communication (IPC) among a plurality of personas in a mobile technology platform (MTP), comprising:
registering a service operable in a first persona of the plurality of personas as a global service;
publishing the global service as available to at least a second persona of the plurality of personas; and
allowing direct IPC communication between the global service to at least a service operable in the at least second persona, wherein the first persona and the at least second persona are contained in at least two different namespaces.

31. The method of claim 30, wherein the IPC communication includes at least a binder transaction.

32. The method of claim 30, wherein the global service is any one of: a process of an operating system, and a process of an application installed on the MTP.

33. The method of claim 30, wherein each persona is defined with a unique set of user preferences associated with a respective persona.

34. The method of claim 30, further comprising:
reverse proxying of requests for services initiated by the at least second persona.

35. A non-transitory computer readable medium having stored thereon instructions for causing one or more processing units to execute the method according to claim 30.

36. A system for performing inter-process communication (IPC) transactions to provide services to multiple personas through a mobile technology platform, comprising:
a processor; and
a memory communicatively connected to the processor, the memory containing instructions that, when executed by the processor, configure the processor to:
receive a request for an IPC transaction from a requesting service to provide services to the multiple personas;
analyze the request to determine the services provided by the requesting service;
identify at least one persona of the multiple personas in need for at least one service of the services provided by the requesting service; and
enable execution of the IPC transaction with the at least one identified persona.

37. A system for inter-process communication (IPC) among a plurality of personas in a mobile technology platform, comprising:
a processor; and
a memory communicatively connected to the processor, the memory containing instructions that, when executed by the processor, configure the processor to:
register a service operable in a first persona of the plurality of personas as a global service;
publish the global service as available to at least a second persona of the plurality of personas; and
allow direct IPC communication between the global service to at least a service operable in the at least second persona, wherein the first persona and the at least second persona are contained in at least two different namespaces.
